(19) United States
(12) Patent Application Publication
(10) Pub. No.: US 2020/0021354 A1
(43) Pub. Date: Jan. 16, 2020

(54) EMERGENCY RESPONDER INSTALL METHOD

(71) Applicant: Wilson Electronics, LLC, St. George, UT (US)

(72) Inventors: Christopher Ken Ashworth, St. George, UT (US); Michael James Mouser, Cedar City, UT (US)

(21) Appl. No.: 16/508,150

(22) Filed: Jul. 10, 2019

Related U.S. Application Data
(60) Provisional application No. 62/696,294, filed on Jul. 10, 2018.

(51) Int. Cl. H04B 7/155; H01Q 1/52; H01Q 1/32; H01Q 1/12

(52) U.S. Cl. CPC H04B 7/155; H01Q 1/1235; H01Q 1/32; H01Q 1/525

(57) ABSTRACT

Technology for a vehicle on-frequency repeater system is disclosed. The vehicle repeater can comprise a donor antenna. The vehicle repeater can comprise a server antenna. The vehicle repeater can comprise a first direction amplification path communicatively coupled between the donor antenna and the server antenna. The vehicle repeater can comprise a second direction amplification path communicatively coupled between the donor antenna and the server antenna. The donor antenna can be configured to be mounted on an exterior of a vehicle. The server antenna can be configured to be mounted on or directed towards an exterior of the vehicle facing substantially away from the vehicle to provide an amplified radio frequency signal about the vehicle for communicating with a communication system.

### RELATED APPLICATIONS

The present application claims the benefit of U.S. Provisional Patent Application No. 62/696,294 filed Jul. 10, 2018, the entire specification of which is hereby incorporated by reference in its entirety for all purposes.

### BACKGROUND

In a wireless communication system, communication may occur as uplink communications or downlink communications. Uplink communications may refer to uplink signals that originate at a wireless communication device (referred to hereinafter as “wireless device”) and are transmitted to an access point (e.g., base station, remote radio head, wireless router, etc.) in the wireless communication system. Downlink communications may refer to downlink signals that originate at the access point and are transmitted to the wireless device.

In one example, a wireless device may be positioned in a wireless communication system such that the wireless device does not adequately receive downlink communications from an access point and/or transmit uplink communications to an access point in the wireless communication system. In these situations, a user of the wireless device may employ a repeater to boost the uplink and/or downlink: communications for the wireless device. Repeaters can improve a quality of the communication by amplifying, filtering, and/or applying other processing techniques to uplink and downlink signals communicated between the wireless device and the access point.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a repeater in communication with a wireless device and a base station, in accordance with an example;

FIG. 2A illustrates a diagram of the side view of a vehicle repeater system installed on a vehicle, in accordance with an example;

FIG. 2B illustrates a diagram of the top view of a vehicle repeater system installed on a vehicle, in accordance with an example;

FIG. 2C illustrates a diagram of the top view of the vehicle repeater system installed on a vehicle with detachable server antennas, in accordance with an example;

FIG. 3 illustrates a cellular repeater configured to amplify uplink (UL) and downlink (DL) signals using one or more downlink signal paths and one or more uplink signal paths in accordance with an example;

FIG. 4 depicts functionality of a method of installing a vehicle repeater system, in accordance with an example.

Reference will now be made to the exemplary embodiments illustrated, and specific language will be used herein to describe the same. It will nevertheless be understood that no limitation of the scope of the technology is thereby intended.

### DETAILED DESCRIPTION

Before the present technology is disclosed and described, it is to be understood that this technology is not limited to the particular structures, process actions, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating actions and operations and do not necessarily indicate a particular order or sequence.

For purposes of the present invention, the following definitions are provided. The terms “cellular” and “cellular network” refer to a wireless telephone network that connects radio transmissions between a mobile phone and a system of multiple cell sites, each including an antenna and a base station, to a mobile telephone switching office, and ultimately to the public wire line telephone system. Cellular calls are transferred from base station to base station as a user travels from cell to cell. One of skill in the art can appreciate that embodiments of the invention can be applied to other wireless networks including those operating on various frequencies throughout the electromagnetic spectrum.

By way of example, the phrase “cell phone” or “cellular phone” refer to a wireless device that sends and receives messages using radio frequency signals in the appropriate band. Likewise, as used herein, the phrase “cellular signal” refers to signals being transmitted both in the cell phone spectrum (i.e., 824-894 MHz) and in the Personal Communication Spectrum PCS (i.e., 1850-1990 MHz). One of skill in the art can appreciate that embodiments of the invention are not limited to operation in these frequency spectrums, but can be applied in other portions of the frequency spectrum as well. For example, the expanding use of fourth generation cellular technologies and fifth generation cellular technologies are using ever expanding portions of the radio frequency spectrum, including a lower Gigahertz (GHz) range of 1 to 30 GHz, and the so-called millimeter wave frequencies in the 30-70 GHz range. In addition, other wireless devices such as personal digital assistants, laptop computers, and the like can benefit from or be incorporated into embodiments of the invention.

“Cell site” and “base station” are used herein interchangeably. Cell site and base station are defined as the location where the wireless network antenna and communications equipment is placed. A cell site or base station typically includes a transmitter/receiver, antenna tower, transmission radios and radio controllers for maintaining communications with mobile handsets within a given range.

A cell phone or cellular device may represent one or more such devices. Similarly, base station or cell site can refer to one or more base stations. Cell phone may also represent other devices that communicate through the amplifier. Embodiments of the amplifier, for example, may amplify signals for one or more cell phones in communication with one or more base stations.

The phrase “uplink signal” refers to the transmission path of a signal being transmitted from a handset to a base station. The phrase “downlink signal” refers to the transmission path of a signal being transmitted from the base station to the handset. The phrases “uplink signal” and “downlink” signal are not limited to any particular type of data that may be transmitted between a handset and a base station, but instead are simply used to specify the direction in which a signal is being transmitted.

The term “repeater” or “cellular repeater”, as used herein, refers to a repeater that is capable of receiving, filtering, amplifying, and transmitting both the uplink signal and the downlink signal transmitted in a cellular system between a cell phone and a base station. The repeater can be referred to as an “on-frequency repeater” as the same frequency signals are received and transmitted. The uplink signals and downlink signals are not converted to a different frequency or radio access technology. The on-frequency repeater is used only for cellular radio access technologies.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

The present technology provides for a repeater install process that enables local coverage without special setup on-site. Mobile device users can arrive at a location, where a repeater system is positioned, and obtain cellular coverage available in that location. A donor antenna may be located on the upper portion of a vehicle and centered above a vehicle for maximum donor antenna and server antenna isolation. Server antennas may be pre-installed outside of the vehicle, or within the vehicle while facing out of the vehicle. One or more server antennas can be included around the vehicle. The repeater may provide coverage within the vehicle as well as the outside of the vehicle to a configured or predetermined range away from the vehicle.

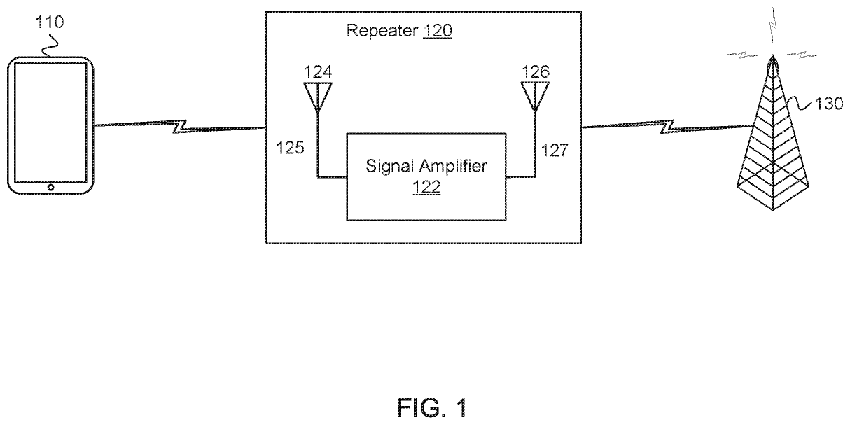

FIG. 1 illustrates an exemplary repeater 120 in communication with a wireless device 110 and a base station 130. The repeater 120 can be referred to as a signal repeater. A repeater can be an electronic device used to amplify (or boost) radio frequency signals. The repeater 120 (also referred to as a cellular signal amplifier) can improve the quality of a wireless communication by amplifying, filtering, and/or applying other processing techniques via a signal amplifier 122 to uplink signals communicated from the wireless device 110 to the base station 130 and/or downlink signals communicated from the base station 130 to the wireless device 110. In other words, the repeater 120 can amplify or boost uplink signals and/or downlink signals bi-directionally. In one example, the repeater 120 can be at a fixed location, such as in a home or office. Alternatively, the repeater 120 can be attached to a mobile object, such as a vehicle or a wireless device 110.

In one configuration, the repeater 120 can include a server antenna 124 (e.g., an inside antenna, a coupling antenna or a device antenna) and a donor antenna 126 (e.g., an outside antenna or a node antenna). The donor antenna 126 can receive the downlink signal from the base station 130. The downlink signal can be provided to the signal amplifier 122 via a transmission line, such as a second coaxial cable 127 or other type of radio frequency connection operable to communicate radio frequency signals. The signal amplifier 122 can include one or more cellular signal amplifiers for amplification and filtering of the downlink signal. The downlink signal that has been amplified and filtered can be provided to the server antenna 124 via a transmission line, such as a first coaxial cable 125 or other type of radio frequency connection operable to communicate radio frequency signals. The server antenna 124 can wirelessly communicate the downlink signal that has been amplified and filtered to the wireless device 110.

Similarly, the server antenna 124 can receive an uplink signal from the wireless device 110. The uplink signal can be provided to the signal amplifier 122 via the first coaxial cable 125 or other type of radio frequency connection operable to communicate radio frequency signals. The signal amplifier 122 can include one or more cellular signal amplifiers for amplification and filtering. The uplink signal that has been amplified and filtered can be provided to the donor antenna 126 via the second coaxial cable 127 or other type of radio frequency connection operable to communicate radio frequency signals. The donor antenna 126 can wirelessly communicate the uplink signal that has been amplified and filtered to the base station 130.

In one example, the repeater 120 can filter the uplink and downlink signals using any suitable analog or digital filtering technology including, but not limited to, surface acoustic wave (SAW) filters, bulk acoustic wave (BAW) filters, film bulk acoustic resonator (FBAR) filters, ceramic filters, waveguide filters or low-temperature co-fired ceramic (LTCC) filters.

In one example, the repeater 120 can send uplink signals to a node and/or receive downlink signals from the node. The node can comprise a wireless wide area network (WWAN) access point (AP), a base station (BS), an evolved Node B (eNB), a next generation Node B (gNB), a baseband unit (BBU), a remote radio head (RRH), a remote radio equipment (RRE), a relay station (RS), a radio equipment (RE), a remote radio unit (RRU), a central processing module (CPM), or another type of WWAN node.

In one example, the repeater 120 can include the donor antenna 126 and the server antenna 124. Alternatively, the repeater 120 can comprise the signal amplifier 122. The server antenna 124 and donor antenna 126 can be common off the shelf (COTS) products that can be provided separately from the signal amplifier.

In one example, the repeater 120 can include a battery to provide power to various components, such as the signal amplifier 122, the server antenna 124 and the donor antenna 126. The battery can also power the wireless device 110 (e.g., phone or tablet). Alternatively, the repeater 120 can receive power from the wireless device 110 or another alternating current (AC) or direct current (DC) power source such as a battery in a vehicle, or a vehicle alternator.

In one configuration, the repeater 120 can be a Federal Communications Commission (FCC)-compatible consumer repeater. As a non-limiting example, the repeater 120 can be compatible with FCC Part 20 or 47 Code of Federal Regulations (C.F.R.) Part 20.21 (Mar. 21, 2013). In addition, the handheld booster can operate on the frequencies used for the provision of subscriber-based services under parts 22 (Cellular), 24 (Broadband PCS), 27 (AWS-1, 700 megahertz (MHz) Lower A-E Blocks, and 700 MHz Upper C Block), and 90 (Specialized Mobile Radio) of 47 C.F.R. The repeater 120 can be configured to automatically self-monitor its operation to ensure compliance with applicable noise and gain limits. The repeater 120 can either self-correct or shut down automatically if the repeater's operations violate the regulations defined in 47 CFR Part 20.21. While a repeater that is compatible with FCC regulations is provided as an example, it is not intended to be limiting. The repeater can be configured to be compatible with other governmental regulations based on the location where the repeater is configured to operate.

In one configuration, the repeater 120 can improve the wireless connection between the wireless device 110 and the base station 130 (e.g., cell tower) or another type of wireless wide area network (WWAN) access point (AP) by amplifying desired signals relative to a noise floor. The repeater 120 can boost signals for cellular standards, such as the Third Generation Partnership Project (3GPP) Long Term Evolution (LTE) Release 8, 9, 10, 11, 12, 13, 14, 15, or 16 standards or Institute of Electronics and Electrical Engineers (IEEE) 802.16. In one configuration, the repeater 120 can boost signals for 3GPP LTE Release 16.1.0 (March 2019) or other desired releases.

The repeater 120 can boost signals from the 3GPP Technical Specification (TS) 36.101 (Release 16 Jan. 2019) bands or LTE frequency bands. For example, the repeater 120 can boost signals from the LTE frequency bands: 2, 4, 5, 12, 13, 17, 25, and 26. In addition, the repeater 120 can boost selected frequency bands based on the country or region in which the repeater is used, including any of bands 1-85 or other bands, as disclosed in 3GPP TS 36.104 V16.1.0 (March 2019), and depicted in Table 1:

TABLE 1

| LTE | Uplink (UL) operating | Downlink (DL) operating | |
|---|---|---|---|
| Operating | band BS receive UE transmit | band BS transmit UE receive | Duplex |
| Band | F_{UL}_{_{—}}_{low}-F_{UL}_{_{—}}_{high} | F_{DL}_{_{—}}_{low}-F_{DL}_{_{—}}_{high} | Mode |
| 1 | 1920 MHz-1980 MHz | 2110 MHz-2170 MHz | FDD |
| 2 | 1850 MHz-1910 MHz | 1930 MHz-1990 MHz | FDD |
| 3 | 1710 MHz-1785 MHz | 1805 MHz-1880 MHz | FDD |
| 4 | 1710 MHz-1755 MHz | 2110 MHz-2155 MHz | FDD |
| 5 | 824 MHz-849 MHz | 869 MHz-894 MHz | FDD |
| 6 | 830 MHz-840 MHz | 875 MHz-885 MHz | FDD |
| (NOTE 1) | | | |
| 7 | 2500 MHz-2570 MHz | 2620 MHz-2690 MHz | FDD |
| 8 | 880 MHz-915 MHz | 925 MHz-960 MHz | FDD |
| 9 | 1749.9 MHz-1784.9 MHz | 1844.9 MHz-1879.9 MHz | FDD |
| 10 | 1710 MHz-1770 MHz | 2110 MHz-2170 MHz | FDD |
| 11 | 1427.9 MHz-1447.9 MHz | 1475.9 MHz-1495.9 MHz | FDD |
| 12 | 699 MHz-716 MHz | 729 MHz-746 MHz | FDD |
| 13 | 777 MHz-787 MHz | 746 MHz-756 MHz | FDD |
| 14 | 788 MHz-798 MHz | 758 MHz-768 MHz | FDD |
| 15 | Reserved | Reserved | FDD |
| 16 | Reserved | Reserved | FDD |
| 17 | 704 MHz-716 MHz | 734 MHz-746 MHz | FDD |
| 18 | 815 MHz-830 MHz | 860 MHz-875 MHz | FDD |
| 19 | 830 MHz-845 MHz | 875 MHz-890 MHz | FDD |
| 20 | 832 MHz-862 MHz | 791 MHz-821 MHz | FDD |
| 21 | 1447.9 MHz-1462.9 MHz | 1495.9 MHz-1510.9 MHz | FDD |
| 22 | 3410 MHz-3490 MHz | 3510 MHz-3590 MHz | FDD |
| 23¹ | 2000 MHz-2020 MHz | 2180 MHz-2200 MHz | FDD |
| 24 | 1626.5 MHz-1660.5 MHz | 1525 MHz-1559 MHz | FDD |
| 25 | 1850 MHz-1915 MHz | 1930 MHz-1995 MHz | FDD |
| 26 | 814 MHz-849 MHz | 859 MHz-894 MHz | FDD |
| 27 | 807 MHz-824 MHz | 852 MHz-869 MHz | FDD |
| 28 | 703 MHz-748 MHz | 758 MHz-803 MHz | FDD |
| 29 | N/A | 717 MHz-728 MHz | FDD (NOTE |
| | | | 2) |
| 30 | 2305 MHz-2315 MHz | 2350 MHz-2360 MHz | FDD |
| 31 | 452.5 MHz-457.5 MHz | 462.5 MHz-467.5 MHz | FDD |
| 32 | N/A | 1452 MHz-1496 MHz | FDD (NOTE |
| | | | 2) |
| 33 | 1900 MHz-1920 MHz | 1900 MHz-1920 MHz | TDD |
| 34 | 2010 MHz-2025 MHz | 2010 MHz-2025 MHz | TDD |
| 35 | 1850 MHz-1910 MHz | 1850 MHz-1910 MHz | TDD |
| 36 | 1930 MHz-1990 MHz | 1930 MHz-1990 MHz | TDD |
| 37 | 1910 MHz-1930 MHz | 1910 MHz-1930 MHz | TDD |
| 38 | 2570 MHz-2620 MHz | 2570 MHz-2620 MHz | TDD |
| 39 | 1880 MHz-1920 MHz | 1880 MHz-1920 MHz | TDD |
| 40 | 2300 MHz-2400 MHz | 2300 MHz-2400 MHz | TDD |
| 41 | 2496 MHz-2690 MHz | 2496 MHz-2690 MHz | TDD |
| 42 | 3400 MHz-3600 MHz | 3400 MHz-3600 MHz | TDD |
| 43 | 3600 MHz-3800 MHz | 3600 MHz-3800 MHz | TDD |
| 44 | 703 MHz-803 MHz | 703 MHz-803 MHz | TDD |
| 45 | 1447 MHz-1467 MHz | 1447 MHz-1467 MHz | TDD |
| 46 | 5150 MHz-5925 MHz | 5150 MHz-5925 MHz | TDD (NOTE |
| | | | 3, |
| | | | NOTE 4) |
| 47 | 5855 MHz-5925 MHz | 5855 MHz-5925 MHz | TDD |
| 48 | 3550 MHz-3700 MHz | 3550 MHz-3700 MHz | TDD |
| 49 | 3550 MHz-3700 MHz | 3550 MHz-3700 MHz | TDD (NOTE |
| | | | 8) |
| 50 | 1432 MHz-1517 MHz | 1432 MHz-1517 MHz | TDD |
| 51 | 1427 MHz-1432 MHz | 1427 MHz-1432 MHz | TDD |
| 52 | 3300 MHz-3400 MHz | 3300 MHz-3400 MHz | TDD |
| 53 | 2483.5 MHz-2495 MHz | 2483.5 MHz-2495 MHz | TDD |
| 65 | 1920 MHz-2010 MHz | 2110 MHz-2200 MHz | FDD |
| 66 | 1710 MHz-1780 MHz | 2110 MHz-2200 MHz | FDD (NOTE |
| | | | 5) |
| 67 | N/A | 738 MHz-758 MHz | FDD (NOTE |
| | | | 2) |
| 68 | 698 MHz-728 MHz | 753 MHz-783 MHz | FDD |
| 69 | N/A | 2570 MHz-2620 MHz | FDD (NOTE |
| | | | 2) |
| 70 | 1695 MHz-1710 MHz | 1995 MHz-2020 MHz | FDD⁶ |
| 71 | 663 MHz-698 MHz | 617 MHz-652 MHz | FDD |
| 72 | 451 MHz-456 MHz | 461 MHz-466 MHz | FDD |
| 73 | 450 MHz-455 MHz | 460 MHz-465 MHz | FDD |
| 74 | 1427 MHz-1470 MHz | 1475 MHz-1518 MHz | FDD |
| 75 | N/A | 1432 MHz-1517 MHz | FDD (NOTE |
| | | | 2) |
| 76 | N/A | 1427 MHz-1432 MHz | FDD (NOTE |
| | | | 2) |
| 85 | 698 MHz-716 MHz | 728 MHz-746 MHz | FDD |

(NOTE 1): Band 6, 23 are not applicable.
(NOTE 2): Restricted to E-UTRA operation when carrier aggregation is configured. The downlink operating band is paired with the uplink operating band (external) of the carrier aggregation configuration that is supporting the configured Pcell.
(NOTE 3): This band is an unlicensed band restricted to licensed-assisted operation using Frame Structure Type 3.
(NOTE 4): Band 46 is divided into four sub-bands as in Table 5.5-1A.
(NOTE 5): The range 2180-2200 MHz of the DL operating band is restricted to E-UTRA operation when carrier aggregation is configured.
(NOTE 6): The range 2010-2020 MHz of the DL operating band is restricted to E-UTRA operation when carrier aggregation is configured and TX-RX separation is 300 MHz. The range 2005-2020 MHz of the DL operating band is restricted to E-UTRA operation when carrier aggregation is configured and TX-RX separation is 295 MHz.
(NOTE 7): Void
(NOTE 8): This band is restricted to licensed-assisted operation using Frame Structure Type 3.

In another configuration, the repeater 120 can boost signals from the 3GPP Technical Specification (TS) 38.104 (Release 15 Jan. 2019) bands or 5G frequency bands. In addition, the repeater 120 can boost selected frequency bands based on the country or region in which the repeater is used, including any of bands n1-n86 in frequency range 1 (FR1), n257-n261 in frequency range 2 (FR2), or other bands, as disclosed in 3GPP TS 38.104 V15.5.0 (March 2019), and depicted in Table 2 and Table 3:

TABLE 2

| | Uplink (UL) operating | Downlink (DL) operating | |
|---|---|---|---|
| NR | band | band | |
| operating | BS receive/UE transmit | BS transmit/UE receive | Duplex |
| band | F_{UL,low}-F_{UL,high} | F_{DL,low}-F_{DL,high} | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n12 | 699 MHz-716 MHz | 729 MHz-746 MHz | FDD |
| n20 | 832 MHz-862 MHz | 791 MHz-821 MHz | FDD |
| n25 | 1850 MHz-1915 MHz | 1930 MHz-1995 MHz | FDD |
| n28 | 703 MHz-748 MHz | 758 MHz-803 MHz | FDD |
| n34 | 2010 MHz-2025 MHz | 2010 MHz-2025 MHz | TDD |
| n38 | 2570 MHz-2620 MHz | 2570 MHz-2620 MHz | TDD |
| n39 | 1880 MHz-1920 MHz | 1880 MHz-1920 MHz | TDD |
| n40 | 2300 MHz-2400 MHz | 2300 MHz-2400 MHz | TDD |
| n41 | 2496 MHz-2690 MHz | 2496 MHz-2690 MHz | TDD |
| n50 | 1432 MHz-1517 MHz | 1432 MHz-1517 MHz | TDD |
| n51 | 1427 MHz-1432 MHz | 1427 MHz-1432 MHz | TDD |
| n65 | 1920 MHz-2010 MHz | 2110 MHz-2200 MHz | FDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |
| n86 | 1710 MHz-1780 MHz | N/A | SUL |

TABLE 3

| | Uplink (UL) and Downlink (DL) | |
|---|---|---|
| | operating band | |
| | BS transmit/receive | |
| NR | UE transmit/receive | |
| operating | F_{UL,low}-F_{UL,high} | Duplex |
| band | F_{DL,low}-F_{DL,high} | Mode |
| n257 | 26500 MHz-29500 MHz | TDD |
| n258 | 24250 MHz-27500 MHz | TDD |
| n260 | 37000 MHz-40000 MHz | TDD |
| n261 | 27500 MHz-28350 MHz | TDD |

The number of LTE frequency bands and the level of signal improvement can vary based on a particular wireless device, cellular node, or location. Additional domestic and international frequencies can also be included to offer increased functionality. Selected models of the repeater 120 can be configured to operate with selected frequency bands based on the location of use. In another example, the repeater 120 can automatically sense from the wireless device 110 or base station 130 (or GPS, etc.) which frequencies are used, which can be a benefit for international travelers.

In one example, the server antenna 124 and the donor antenna 126 can each be comprised of a single antenna, an antenna array, or have a telescoping form-factor. In another example, the server antenna 124 and the donor antenna 126 can be a microchip antenna. An example of a microchip antenna is AMMAL001. In yet another example, the server antenna 124 and the donor antenna 126 can be a printed circuit board (PCB) antenna. An example of a PCB antenna is TE 2118310-1.

In one example, the server antenna 124 can receive uplink (UL) signals from the wireless device 110 and transmit DL signals to the wireless device 110 using a single antenna or array of antennas that can be used for both DL and UL communications. Alternatively, the server antenna 124 can receive UL signals from the wireless device 110 using a dedicated UL antenna or array of dedicated UL antennas, and the server antenna 124 can transmit DL signals to the wireless device 110 using a dedicated DL antenna or array of dedicated DL antennas. The arrays of UL and DL antennas can be configured to electronically steer one or more received and/or transmitted wireless signal beams.

In one example, a server antenna 124 can communicate with the wireless device 110 using near field communication. Alternatively, the server antenna 124 can communicate with the wireless device 110 using far field communication.

In one example, the donor antenna 126 can receive downlink (DL) signals from the base station 130 and transmit uplink (UL) signals to the base station 130 via a single antenna, or array of antennas that can be used for both UL and DL communications. Alternatively, the donor antenna 126 can receive DL signals from the base station 130 using a dedicated DL antenna or array of dedicated DL antennas, and the donor antenna 126 can transmit UL signals to the base station 130 using a dedicated UL antenna or array of dedicated UL antennas.

In one configuration, multiple signal amplifiers 122 can be used in a single repeater 120 to amplify UL and DL signals. For example, a first signal amplifier can be used to amplify UL signals and a second signal amplifier can be used to amplify DL signals. In addition, different signal amplifiers in a repeater 120 can be used to amplify different frequency ranges, referred to as bands and/or channels within a band.

In one configuration, the repeater 120 can be configured to identify when the wireless device 110 receives a relatively strong downlink signal. An example of a strong downlink signal can be a downlink signal with a signal strength greater than approximately −80 dBm. The repeater 120 can be configured to automatically turn off selected features, such as amplification, to conserve battery life. When the repeater 120 senses that the wireless device 110 is receiving a relatively weak downlink signal, the repeater 120 can be configured to provide amplification of the downlink signal. An example of a weak downlink signal can be a downlink signal with a signal strength less than −80 dBm.

In one example the signal repeater 120 can also include extra memory storage. In one example, extra memory storage can be used to assist with a direct connection between the signal repeater 120 and the wireless device 110. In another example, Near-Field Communications (NFC), Bluetooth v4.0, Bluetooth Low Energy, Bluetooth v4.1, Bluetooth v4.2, Bluetooth 5, Ultra High Frequency (UHF), 3GPP LTE v.8 through v.15, Institute of Electronics and Electrical Engineers (IEEE) 802.11a, IEEE 802.11b, IEEE 802.11g, IEEE 802.11n, IEEE 802.11ac, IEEE 802.11ad, IEEE 802.11-2016, IEEE 802.11 ah, IEEE 802.11ai, IEEE 802.11aj, IEEE 802.11aq, IEEE 802.11ax, IEEE 802.11ay, or IEEE 802.11be can be used to couple the repeater 120 with the wireless device 110 to enable data or control information from the signal from the wireless device 110 to be communicated to and stored in the extra memory storage that is integrated in the signal repeater 120 between the wireless device 110 and the repeater 120. The memory can be used to buffer information communicated through the repeater between the wireless device 110 and the base station 130.

In one example, the repeater 120 can include photovoltaic cells or solar panels as a technique of charging a battery used to provide power to the repeater 120 and/or a battery of the wireless device 110. In another example, the repeater 120 can be configured to communicate directly with other repeaters. In one example, the donor antenna 126 can communicate over Very High Frequency (VHF) communications directly with donor antennas of other repeaters. The repeater 120 can be configured to communicate with the other repeaters and/or the wireless device 110 through a direct connection, Near-Field Communications (NFC), Bluetooth v4.0, Bluetooth Low Energy, Bluetooth v4.1, Bluetooth v4.2, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, IEEE 802.11ad, IEEE 802.11-2016, IEEE 802.11 ah, IEEE 802.11ai, IEEE 802.11aj, IEEE 802.11aq, IEEE 802.11ax, IEEE 802.11ay, or IEEE 802.11be, a TV White Space Band (TVWS), or any other industrial, scientific and medical (ISM) radio band. Examples of such ISM bands include 2.4 GHz, 3.6 GHz, 4.9 GHz, 5 GHz, or 5.9 GHz. This configuration can allow data to pass at high rates between multiple wireless devices with signal repeaters. This configuration can also allow users to send text messages, initiate phone calls, and engage in video communications between wireless devices with signal repeaters. In one example, the donor antenna 126 can be configured to couple to the wireless device 110. In other words, communications between the donor antenna 126 and the wireless device 110 can bypass the repeater 120.

In another example, the donor antenna 126 to be used for simultaneous cellular communications. Alternatively, the separate node antenna can be configured to communicate with the wireless device 110 through a direct connection, Near-Field Communications (NFC), Bluetooth v4.0, Bluetooth Low Energy, Bluetooth v4.1, Bluetooth v4.2, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, IEEE 802.11ad, IEEE 802.11-2016, IEEE 802.11 ah, IEEE 802.11ai, IEEE 802.11aj, IEEE 802.11aq, IEEE 802.11ax, IEEE 802.11 ay, or IEEE 802.11be, a TV White Space Band (TVWS), or any other industrial, scientific and medical (ISM) radio band.

In one configuration, the repeater 120 can be configured for satellite communication. In one example, the donor antenna 126 can be configured to act as a satellite communication antenna. In another example, a separate donor antenna can be used for satellite communications. The repeater 120 can extend the range of coverage of the wireless device 110 configured for satellite communication. The donor antenna 126 can receive downlink signals from satellite communications for the wireless device 110. The repeater 120 can filter and amplify the downlink signals from the satellite communication. In another example, during satellite communications, the wireless device 110 can be configured to couple to the repeater 120 via a direct connection or an ISM radio band. Examples of such ISM bands include 2.4 GHz, 3.6 GHz, 4.9 GHz, 5 GHz, or 5.9 GHz.

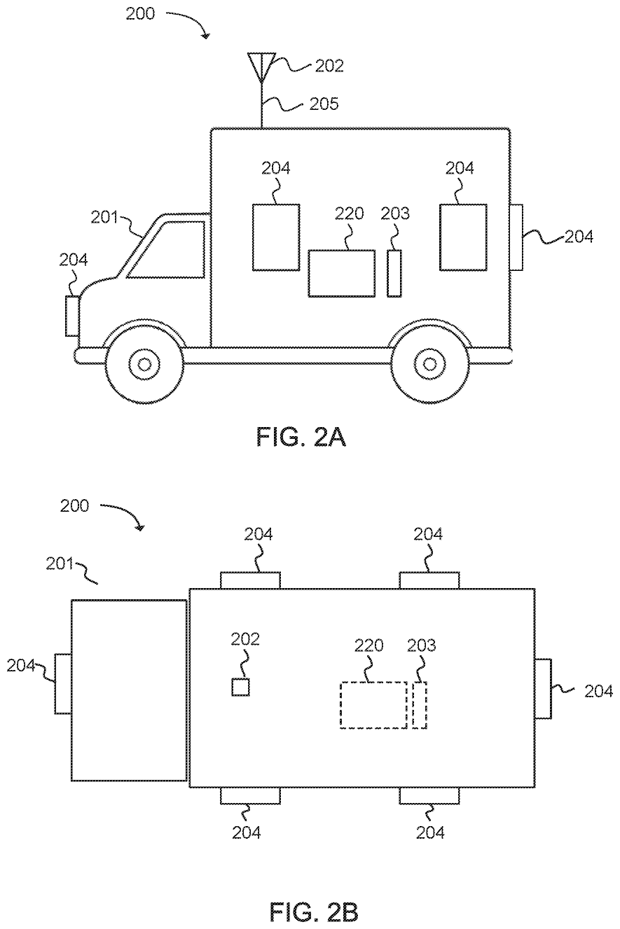

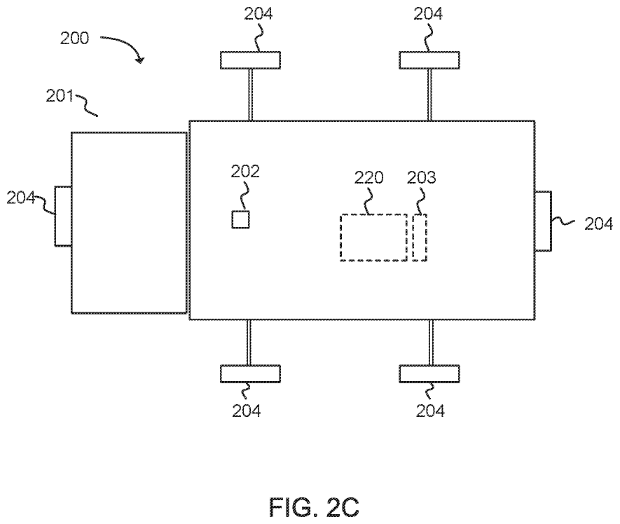

FIG. 2A illustrates a diagram of a side view of a vehicle repeater system 200 installed on a vehicle, in accordance with an example. In addition, FIG. 2B illustrates a diagram of a top view of the vehicle repeater system 200 installed on a vehicle. The vehicle repeater system can be installed on various types of vehicles, and can be useful for vehicles used by emergency responders, recreational vehicles (RVs), or other mobile applications where users may want coverage in a local area surrounding the vehicle. Vehicle repeater systems typically provide increased coverage within the interior of a vehicle. The increased coverage quickly degrades outside of the vehicle. Accordingly, when people exit their vehicles in remote locations, the ability to communicate via a wireless device is substantially limited.

In one embodiment, the vehicle repeater system 200 can comprise a donor antenna 202 and one or more server antennas 204 connected to a cellular signal repeater or other type of repeater 220. The repeater 220 can be located within the vehicle 201 or may be configured to be setup outside the vehicle 201. In one embodiment, the repeater 220 can be an on-frequency repeater configured to receive and transmit signals without changing the frequency of the signals. The repeater 220 can be powered using the vehicle 201, such as a connection to a vehicle battery and/or vehicle alternator. Alternatively, a separate battery system 203 can be used to power the vehicle repeater system 200. The separate battery system 203 can be charged using the vehicle battery and/or alternator.

The donor antenna 202 and server antennas 204 can be located outside of the vehicle 201 to provide radio frequency communication about a selected geographic area relative to the vehicle, such as a cellular communication service. The donor antenna 202 can be configured to communicate with one or more wireless base stations (130, FIG. 1), such as an evolved node B (eNB) or a new radio (NR) next generation node B (gNB).

In one example, the donor antenna 202 can be installed on a pole, tripod, or other type of device to elevate the donor antenna 202 above the vehicle 201. Elevating the donor antenna 202 can provide better line of site communications between the donor antenna and base station 130 (FIG. 1). Elevating the donor antenna 202 can also provide increased radio frequency isolation between the donor antenna 202 and the one or more server antennas 204. The vehicle repeater system can be configured to be a plug and play system. The plug and play system can be configured to be operable to perform as a repeater system without needing additional setup, configuration, or end-user assistance. The system can be further configured to be operable upon connection and start-up at a desired location.

In one embodiment, the vehicle repeater system 200 can be installed on an emergency vehicle, and configured to operate in an area with low signal coverage. For example, the vehicle 201 can travel to an emergency site. At the emergency site, the vehicle repeater system 200 can enable wireless devices access to cellular signals, which the wireless devices would otherwise not be capable of receiving, in a defined geographic region about the vehicle 201. The vehicle repeater system 200 can be set up to provide radio frequency coverage for wireless devices about the vehicle 201 within a predetermined range of the vehicle 201. This can allow emergency responders to effectively communicate using wireless devices, such as cell phones or emergency responder radios, at locations in which cellular wireless communication is not otherwise available.

In another embodiment, the vehicle repeater system can be installed on a recreational vehicle, such as a trailer, a mobile home, or a motor home, or another type of vehicle, as desired. The vehicle repeater system can be configured to provide radio frequency coverage for wireless devices about the vehicle 201, such as a recreational vehicle, within a predetermined range of the vehicle. The donor antenna 202 can be configured to be directed towards a desired base station to optimize downlink signal power received at the donor antenna. The donor antenna may be directed manually or automatically to optimize the downlink signal power received at the donor antenna.

In one embodiment, the vehicle repeater system 200 can include at least one donor antenna 202 and at least one server antenna 204. The donor antenna can be configured to be extended above the vehicle, as previously discussed, and to retract or lay down when not in use. The donor antenna can be an omni-directional antenna or a directional antenna. An emergency responder, or an individual within the predetermined range, can use the vehicle repeater system 200 to receive a downlink signal at a mobile device via the vehicle repeater system 200.

In one embodiment, the vehicle repeater system 200 can include a plurality of server antennas 204. For example, the server antenna can be directional antennas configured to radiate away from the vehicle 201 in a desired direction. The directional antennas can be located on the vehicle at locations that allow substantially complete coverage at locations around the vehicle. The use of multiple directional server antennas can enable the vehicle repeater system 200 to provide coverage over a larger geographic area around the vehicle 201. The vehicle repeater system 200 does not include the vehicle 201. However, the vehicle repeater system 200 can be configured for installation on one or more types of selected vehicles or trailers.

In one embodiment, the vehicle repeater system 200 can transmit a downlink signal, received at the donor antenna 202, from the repeater 220, to be transmitted from each of the plurality of server antennas 204. Each server antenna can be communicatively coupled to the donor antenna via a radio frequency splitter. The splitter can be an equal splitter (i.e. divide the power equally to 2, 3, 4, or n ports, where n is a positive number greater than 1). Alternatively, the splitter can be configured to provide more power to one or more ports, as desired. Uplink signals received by one or more server antennas 204 can be communicated to the repeater 220. In one example, the uplink signals received at multiple repeater antennas can be combined, filtered, and amplified in the repeater 220 for transmission at the donor antenna 202 to a base station. Alternatively, of the multiple received uplink signals, a single uplink signal with a highest power can be selected for filtering and amplification at the repeater 220, and then transmitted via the donor antenna 202.

In one embodiment, the donor antenna 202 and server antenna(s) 204 can be configured to be isolated in order to prevent interference between the donor antenna(s) and server antenna(s) or interference from signals transmitted by other repeater systems in the surrounding areas. For example, the donor antenna can be placed on an extendable pole 205 to provide an increased amount of isolation with the server antenna(s). The extendable pole may vary in height from 2 feet to 20 or more feet in length. In addition, radiation patterns of the donor antenna(s) and the server antenna(s) can be configured to assist with the isolation between the donor antenna(s) and server antenna(s). In addition, shielding can be used to further isolate a server antenna and a donor antenna.

For example, the donor antenna 202 can include a radio frequency (RF) shield, such as a metallic screen or solid surface, positioned under the donor antenna, to limit radio frequency transmission in a direction towards the server antenna(s) 204, and reception of radio frequency signals from the server antenna(s) 204. In addition, a server antenna 204 can include an RF shield, such as a metallic screen or a solid surface, which can be positioned or extended over a top of a server antenna to limit radio frequency transmission in a direction towards the donor antenna 202, and reception of radio frequency signals from the donor antenna 202. In one embodiment, the repeater 220 can include multiple preset amplification levels. When the shield(s) are installed at the donor antenna(s) or the server antenna(s) the amplification level at the repeater can be increased, either manually or automatically, depending on a distance of the vehicle repeater system 200 from the base station.

In one embodiment, the vehicle repeater system 200 can be configured to have a selected vehicle gain limit, such as 50 dB. The actual gain limit can depend on government set limits for a repeater installed on a vehicle. If a repeater is installed within a building structure, a maximum gain can be a second repeater gain level, such as within the 65 to 70 dB range.

In one embodiment, the vehicle repeater system 200 installed within a vehicle can include a motion detector to determine if the repeater or vehicle is moving. When the repeater or vehicle has not moved for a period of time, the gain of the repeater 220 can be increased from the vehicle repeater limit of 50 dB to a greater value, such as 65 to 70 dB. If there is movement, the maximum gain can be switched to the vehicle repeater limit, such as 50 dB. The gain values listed here are not intended to be limiting. The actual gain values can be selected based on system design, system location, and governmental regulations. The motion detector can be comprised of one or more of an accelerometer, a gyroscope, a communication with the vehicle 201, or another desired means for determining when the vehicle is moving. The ability to detect motion can be useful when the vehicle repeater system is installed in a mobile home or trailer. The power can be maximized when the vehicle is stationary at a camping site, and then automatically reduced when the vehicle is in motion on a road, thereby ensuring that governmental regulations are met.

In one embodiment, the vehicle repeater system 200 can be configured to communicate using both a wireless wide area network (WWAN) communication standard, such as 3GPP LTE, and a wireless local area network (WLAN) standard, such as IEEE 802.11 or Bluetooth. For example, the vehicle repeater system 200 can also be configured such that the donor antenna 202 is configured to transmit and receive a WWAN cellular signal with a base station. The server antenna(s) 204 can be configured to transmit and/or receive WLAN signals with wireless devices.

In one example, the vehicle repeater system 200 can also be configured to transmit and receive voice over internet protocol (VoIP) and voice over LTE (VoLTE).

In one embodiment, the vehicle repeater system can be configured to be installed and utilized on a Paladin system, where the mobile repeater system or vehicle repeater system can be installed on a tripod or pole like system 205, comprising one or more, or all of the embodiments described above. Additionally, the Paladin system can be comprised of a series of tripod or pole like systems that can interact in a communicative fashion in order to ensure the efficiency of operation, and boosting of signals received. For example, the donor antenna 202 may be detached from a vehicle and placed on a separate poll or tripod.

In addition, one or more of the server antennas 204 can be detachable from the vehicle and mounted on a pole or tripod, as illustrated in FIG. 2C. Mounting the server antennas on a poll or tripod can be used to increase isolation between the donor and server antenna(s), thereby enabling greater amplification levels. A coaxial cable or other RF communication connection can be used to connect the server antennas to the repeater 220.

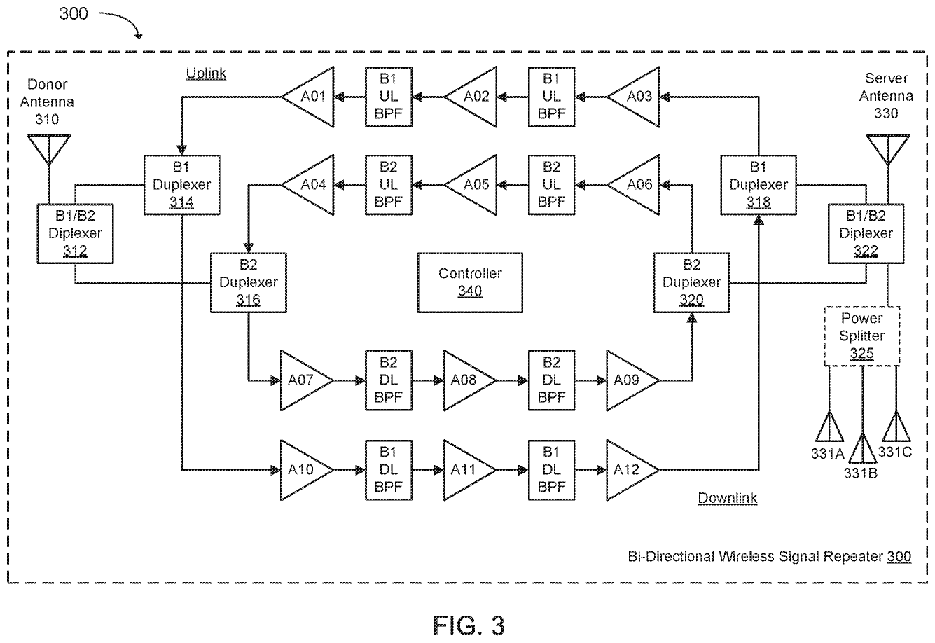

FIG. 3a illustrates an exemplary dual-band bi-directional wireless repeater 300 configured to amplify uplink (UL) and downlink (DL) signals using a separate signal path for each UL frequency band 1/band 2 (B1/B2) and DL frequency band B1/B2 and a controller 340. Alternatively, a signal path can be used for two or more UL or DL bands. A donor antenna 310, or an integrated donor antenna, can receive a downlink signal. For example, the downlink signal can be received from a base station (130, FIG. 1). The downlink signal can be provided to a first B1/B2 diplexer 312, wherein B1 represents a first frequency band and B2 represents a second frequency band. The first B1/B2 diplexer 312 can create a B1 downlink signal path and a B2 downlink signal path. Therefore, a downlink signal that is associated with B1 can travel along the B1 downlink signal path to a first B1 duplexer 314, or a downlink signal that is associated with B2 can travel along the B2 downlink signal path to a first B2 duplexer 316.

After passing the first B1 duplexer 314, the downlink signal can travel through a series of amplifiers (e.g., A10, A11 and A12) and downlink band pass filters (BPF) to a second B1 duplexer 318. Alternatively, after passing the first B2 duplexer 316, the downlink can travel through a series of amplifiers (e.g., A07, A08 and A09) and downlink band pass filters (BFF) to a second B2 duplexer 320. At this point, the downlink signal (B1 or B2) has been amplified and filtered in accordance with the type of amplifiers and BPFs included in the bi-directional wireless repeater 300. The downlink signals from the second B1 duplexer 318 or the second B2 duplexer 320, respectively, can be provided to a second B1/B2 diplexer 322. The second B1/B2 diplexer 322 can provide an amplified downlink signal to a server antenna 330, or an integrated server antenna. The server antenna 330 can communicate the amplified downlink signal to a wireless device (not shown), such as a mobile phone, laptop computer, tablet, internet of things (IoT) enabled device, machine type communications (MTC) enabled communication device, or other type of wireless device.

In one example, the server antenna 330 can receive an uplink (UL) signal from the wireless device. The uplink signal can be provided to the second B1/B2 diplexer 322. The second B1/B2 diplexer 322 can create a B1 uplink signal path and a B2 uplink signal path. Therefore, an uplink signal that is associated with B1 can travel along the B1 uplink signal path to the second B1 duplexer 318, or an uplink signal that is associated with B2 can travel along the B2 uplink signal path to the second B2 duplexer 322. After passing the second B1 duplexer 318, the uplink signal can travel through a series of amplifiers (e.g., A01, A02 and A03) and uplink band pass filters (BPF) to the first B1 duplexer 314. Alternatively, after passing the second B2 duplexer 320, the uplink signal can travel through a series of amplifiers (e.g., A04, A05 and A06) and uplink band pass filters (BPF) to the first B2 duplexer 316. At this point, the uplink signal (B1 or B2) has been amplified and filtered in accordance with the type of amplifiers and BFFs included in the bi-directional wireless repeater 300. The uplink signals from the first B1 duplexer 314 or the first B2 duplexer 316, respectively, can be provided to the first B1/B2 diplexer 312. The first B1/B2 diplexer 312 can provide an amplified uplink signal to the donor antenna 310. The donor antenna can communicate the amplified uplink signal to the base station.

In one example, the bi-directional wireless repeater 300 can be a 3-band, 4-band, 5-band, or 6-band repeater. In other words, the bi-directional wireless repeater 300 can perform amplification and filtering for downlink and uplink signals having selected frequency bands. In one example the frequency bands can be selected from the 3GPP Technical Specification (3GPP TS) 36.101 or 38.101.

In one example, the bi-directional wireless repeater 300 can use the duplexers to separate the uplink and downlink frequency bands, which are then amplified and filtered separately. A multiple-band cellular repeater can typically have dedicated radio frequency (RF) amplifiers (gain blocks), RF detectors, variable RF attenuators and RF filters for each uplink and downlink band.

In one example, an optional power splitter/combiner 325 can be included to divide the downlink power to multiple server antennas. In this example, server antennas 331A, 331B, and 331C can be configured to receive downlink power from the diplexer 322. While three additional server antennas are shown, this is not intended to be limiting. The system 300 can include one or more server antennas. In a single band system, the power splitter/combiner 325 can be coupled directly to the duplexer 320. The power splitter/combiner 325 may be configured to evenly divide the power to each server antenna. Alternatively, an uneven power distribution may be preferred. For example, more downlink power may be directed to a selected server antenna to cover a larger geographic region than other server antennas. Uplink power received at each server antenna 331A, 331B, 331C can be combined at the power splitter/combiner 325.

In one embodiment the vehicle repeater system can comprise a donor antenna. The vehicle repeater system can comprise a server antenna. The vehicle repeater system can comprise a first direction amplification path communicatively coupled between the donor antenna and the server antenna. The vehicle repeater system can comprise a second direction amplification path communicatively coupled between the donor antenna and the server antenna. The donor antenna can be configured to be mounted on the exterior of a vehicle. The server antenna can be configured to be mounted on the exterior of the vehicle facing substantially away from the vehicle to provide an amplified radio frequency signal about the vehicle for communicating with a communication system.

In one embodiment, the donor antenna is mounted on a telescoping pole, expandable pole, multiple piece pole device, or an extending device to enable the donor antenna to be extended away from the server antenna to provide increased isolation between the donor antenna and the server antenna.

In one embodiment, the donor antenna is mounted on a pivotable pole operable to pivot to be substantially flush with the vehicle.

In one embodiment, the system can further comprise a plurality of server antennas configured to be mounted on the exterior of the vehicle.

In one embodiment, the system can further comprise an antenna port, wherein the antenna port is communicatively coupled to the first direction amplification path and the second directional amplification path and is configured to be mounted on the exterior of the vehicle.

In one embodiment, the system can further comprise a wired connection configured to connect to the antenna port and the server antenna, wherein the wired connection enables the server antenna to be located away from the vehicle.

In one embodiment, the wired connection is one or more of a coaxial cable, a fiber optic cable, or a twisted shielded pair (TSP) cable.

In one embodiment, the amplified radio frequency signal is a cellular radio frequency signal.

In one embodiment, the amplified radio frequency signal is an Industrial Science and Medical (ISM) band radio frequency signal, a modem, or an ISM chip.

In one embodiment, the amplified radio frequency signal is configured for public safety frequency boosting.

In one embodiment, the donor antenna is one of a directional antenna, or an omni-directional antenna.

In one embodiment, the directional antenna is manually steerable or automatically steerable towards a base station.

In one embodiment, the system can further comprise a server antenna configured to be mounted in an interior of the vehicle to provide the amplified radio frequency signal within the vehicle.

In one embodiment the vehicle repeater system can comprise a donor antenna operable to be mounted on an exterior of a vehicle. The vehicle repeater system can comprise a server antenna port operable to be mounted on the exterior of the vehicle. The vehicle repeater system can comprise a repeater communicatively coupled to the donor antenna and the server antenna port.

In one embodiment, the donor antenna is mounted on a telescoping pole to enable the donor antenna to be extended away from a server antenna to provide increased isolation between the donor antenna and the server antenna.

In one embodiment, the donor antenna is mounted on a rotatable pole operable to rotate to be substantially flush with the vehicle.

In one embodiment, the system can further comprise a plurality of server antennas configured to be mounted on the exterior of the vehicle.

In one embodiment, the system can further comprise an antenna port, wherein the antenna port is communicatively coupled to the first direction amplification path and the second directional amplification path and is configured to be mounted on the exterior of the vehicle.

In one embodiment, the system can further comprise a wired connection configured to connect to the antenna port and the plurality of server antennas, wherein the wired connection has a predetermined length to enable the plurality of server antennas to be located the predetermined length from the vehicle.

In one embodiment, the amplified radio frequency signal is an Industrial Science and Medical (ISM) band radio frequency signal.

In one embodiment, the system can comprise a movement detection module operable to determine the vehicle is not moving to enable the vehicle repeater to operate as an in-building repeater to provide additional gain relative to a mobile repeater.

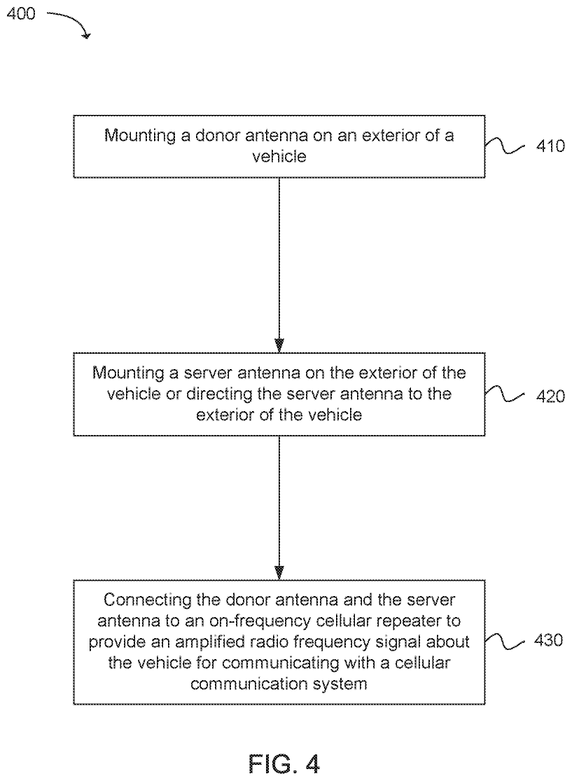

FIG. 4 depicts functionality of a method of installing a vehicle repeater system. The method can comprise mounting a donor antenna on an exterior of a vehicle 410. The method can comprise mounting a server antenna on the exterior of the vehicle or directing the server antenna towards the exterior of the vehicle 420. The method can comprise connecting the donor antenna and the server antenna to an on-frequency cellular repeater to provide an amplified radio frequency signal about the vehicle for communicating with a cellular communication system 430.

In one embodiment, the method can further comprise mounting the donor antenna to the exterior of the vehicle using a telescoping pole.

In one embodiment, the method can further comprise mounting the server antenna to the exterior of the vehicle using a server antenna port connected to the cellular repeater to enable the server antenna to be located remote from the vehicle via a wired connection between the server antenna port and the server antenna.

In one embodiment, the method can comprise determining a predetermined length of the wired connection to enable the server antenna to be located the predetermined length from the vehicle.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present technology may be referred to herein along with alternatives for the various components thereof. It is understood that such embodiments, examples, and alternatives are not to be construed as defacto equivalents of one another, but are to be considered as separate and autonomous representations of the present technology.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the technology. One skilled in the relevant art will recognize, however, that the technology can be practiced without one or more of the specific details, or with other methods, components, layouts, etc. In other instances, well-known structures, materials, or operations are not shown or described in detail to avoid obscuring aspects of the technology.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology. Accordingly, it is not intended that the technology be limited, except as by the claims set forth below.

What is claimed is:

1. A vehicle on-frequency repeater system comprising:
a donor antenna;
a server antenna;
a first direction amplification path communicatively coupled between the donor antenna and the server antenna;
a second direction amplification path communicatively coupled between the donor antenna and the server antenna;
wherein the donor antenna is configured to be mounted on an exterior of a vehicle; and
wherein the server antenna is configured to be mounted on the exterior of the vehicle or is mounted facing substantially away from the vehicle to provide an amplified radio frequency signal about the vehicle for communicating with a wireless device.

2. The vehicle on-frequency repeater system of claim 1, wherein the donor antenna is mounted on a telescoping pole to enable the donor antenna to be extended away from the server antenna to provide increased isolation between the donor antenna and the server antenna.

3. The vehicle on-frequency repeater system of claim 1, wherein the donor antenna is mounted on a pivotable pole operable to pivot to be substantially flush with the vehicle.

4. The vehicle on-frequency repeater system of claim 1, further comprising a plurality of server antennas configured to be mounted on the exterior of the vehicle.

5. The vehicle on-frequency repeater system of claim 1, further comprising an antenna port, wherein the antenna port is communicatively coupled to the first direction amplification path and the second directional amplification path, and the antenna port is configured to be mounted on the exterior of the vehicle.

6. The vehicle on-frequency repeater system of claim 5, further comprising a wired connection configured to connect to the antenna port and the server antenna, wherein the wired connection enables the server antenna to be located away from the vehicle.

7. The vehicle on-frequency repeater system of claim 6, wherein the wired connection is one of a coaxial cable, a fiber optic cable, or a twisted shielded pair (TSP) cable.

8. The vehicle on-frequency repeater system of claim 1, wherein the amplified radio frequency signal is a cellular radio frequency signal.

9. The vehicle on-frequency repeater system of claim 1, wherein the amplified radio frequency signal is an Industrial Science and Medical (ISM) band radio frequency signal, wherein the ISM band radio frequency signal is derived using a modem, or an ISM chip.

10. The vehicle on-frequency repeater system of claim 1, wherein the amplified radio frequency signal is utilized for public safety frequency boosting.

11. The vehicle on-frequency repeater system of claim 1, wherein the donor antenna is one of a directional antenna, or an omni-directional antenna.

12. The vehicle on-frequency repeater system of claim 11, wherein the directional antenna is manually steerable or automatically steerable.

13. The vehicle on-frequency repeater system of claim 1, further comprising a server antenna configured to be mounted in an interior of the vehicle to provide the amplified radio frequency signal within the vehicle.

14. A vehicle on-frequency repeater system comprising:
a donor antenna operable to be mounted on an exterior of a vehicle;
a server antenna operable to be mounted on the exterior of the vehicle; and,
a repeater communicatively coupled to the donor antenna and the server antenna.

15. The vehicle on-frequency repeater system of claim 14, wherein the donor antenna is mounted on a telescoping pole to enable the donor antenna to be extended away from the server antenna to provide increased isolation between the donor antenna and the server antenna.

16. The vehicle on-frequency repeater system of claim 14, wherein the donor antenna is mounted on a rotatable pole operable to rotate to be substantially flush with the vehicle.

17. The vehicle on-frequency repeater system of claim 14, further comprising a plurality of server antennas configured to be mounted on the exterior of the vehicle.

18. The vehicle on-frequency repeater system of claim 14, further comprising an antenna port, wherein the antenna port is communicatively coupled to a first direction amplification path in the vehicle repeater system and a second directional amplification path in the vehicle repeater system, and the antenna port is configured to be mounted on the exterior of the vehicle.

19. The vehicle on-frequency repeater system of claim 17, further comprising a wired connection configured to connect to the antenna port and the plurality of server antennas, wherein the wired connection has a predetermined length to enable the plurality of server antennas to be located at a predetermined length away from the vehicle.

20. The vehicle on-frequency repeater system of claim 14, wherein the amplified radio frequency signal is an Industrial Science and Medical (ISM) band radio frequency signal.

21. The vehicle on-frequency repeater system of claim 14, further comprising a movement detection module operable to determine that the vehicle is not moving to enable the vehicle repeater system to operate as a fixed location repeater to provide additional gain relative to a mobile repeater.

22. A method for installing a vehicle repeater system, comprising:
mounting a donor antenna on an exterior of a vehicle;
mounting a server antenna on the exterior of the vehicle or directing the server antenna towards the exterior of the vehicle; and,
connecting the donor antenna and the server antenna to an on-frequency cellular repeater to provide an amplified radio frequency signal about the vehicle for communicating with a cellular communication system.

23. The method of claim 22, further comprising mounting the donor antenna to the exterior of the vehicle using a telescoping pole.

24. The method of claim 22, further comprising mounting the server antenna to the exterior of the vehicle using a server antenna port connected to the cellular repeater to enable the server antenna to be located remote from the vehicle via a wired connection between the server antenna port and the server antenna.

25. The method of claim 24, further comprising determining a predetermined length of the wired connection to enable the server antenna to be located at a predetermined length away from the vehicle.
